(19) United States
(12) Patent Application Publication
(10) Pub. No.: US 2026/0101105 A1
(43) Pub. Date: Apr. 9, 2026

(54) APPARATUS, SYSTEM, AND NON-TRANSITORY STORAGE MEDIUM

(71) Applicant: CANON KABUSHIKI KAISHA, Tokyo (JP)

(72) Inventor: KOICHI TANABE, Kanagawa (JP)

(21) Appl. No.: 19/339,097

(22) Filed: Sep. 24, 2025

(30) Foreign Application Priority Data
Oct. 8, 2024 (JP) 2024-176785

(51) Int. Cl. H04N 23/60; H04N 23/63

(52) U.S. Cl. CPC H04N 23/64; H04N 23/633

(57) ABSTRACT

An apparatus includes an acquisition unit configured to acquire a range of setting values settable for a capturing device, a search unit configured to search sample content stored in a storage unit for sample content corresponding to an image captured using a setting value within the range of setting values acquired by the acquisition unit, and an output unit configured to output a search result from the search unit.

### BACKGROUND

### Field of the Technology

The aspect of the embodiments relates to a system that is capable of communicating via a network and that is for registering, managing, and processing images and to a computer readable storage medium.

### Description of the Related Art

In recent years, it has become possible to easily transfer images captured by image capturing devices such as digital cameras to server devices via wireless communication units included in the image capturing devices.

Japanese Patent Laid-Open No. 2023-62380 discloses that sample images, setting values at the time of image capturing, setting values at the time of development, etc., are provided as sample content in server devices. By selecting favorite sample content, a user can download various setting values to an image capturing device and capture images similar to the sample image.

In a system described in Japanese Patent Laid-Open No. 2023-62380, a search for sample content is performed using, as a search condition, subject information extracted from images captured by the image capturing device.

The system described in Japanese Patent Laid-Open No. 2017-17471 determines the priority order of picture data to be displayed on an image capturing device from picture data (sample content) managed by a web server, based on search conditions such as an image capturing location, weather, and information regarding an image capturing device owned by a user, for example. When the user presses a setting button while picture data is displayed on the image capturing device, the setting information of the image capturing device used in image capturing for the picture data is set for the image capturing device.

In the system described in Japanese Patent Laid-Open No. 2017-17471, a search for sample content is performed using, as part of the search conditions, the name of the image capturing device and the type of lens used by the user.

In the system described in Japanese Patent Laid-Open No. 2023-62380, sample content selection conditions do not include the setting values of the image capturing device. Thus, there is a possibility that sample content captured using setting values that cannot be set for the image capturing device to be used may be searched for. That is, sample content search results may include unnecessary sample content that cannot be used.

In contrast, in the system described in Japanese Patent Laid-Open No. 2017-17471, sample content is narrowed down using the name of the image capturing device. Thus, sample content captured using an image capturing device with a different name from the image capturing device in question is not selected. Thus, even if the sample content was captured using setting values that can be set for the image capturing device to be used, there is a possibility that the sample content is not included in the search results because the name of the image capturing device is different.

### SUMMARY

An apparatus according to an aspect of the embodiments includes an acquisition unit configured to acquire a range of setting values settable for a capturing device, a search unit configured to search sample content stored in a storage unit for sample content corresponding to an image captured using a setting value within the range of setting values acquired by the acquisition unit, and an output unit configured to output a search result from the search unit.

Features of the disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a system configuration of an information processing apparatus.

FIG. 2 is a diagram illustrating an example of the hardware configuration of the information processing apparatus.

FIG. 3 is a diagram illustrating an example of the configuration of an application on the information processing apparatus.

FIG. 4 illustrates an example of a data structure for managing image capture recipes.

FIG. 5A illustrates a data structure for managing information regarding cameras that can communicate, and FIG. 5B illustrates a data structure for managing information regarding lenses.

FIG. 6 illustrates an example of a data structure for managing information regarding cameras and lenses owned by users.

FIG. 7 illustrates an example of a data structure for managing images captured by users.

FIG. 8 is a flowchart illustrating an example of a process for searching for image capture recipes.

FIG. 9A illustrates an example of an image capture recipe list screen displaying image capture recipes, and FIG. 9B illustrates an example of an image capture recipe details screen.

FIG. 10 is a flowchart illustrating an example of a process for determining an image capture recipe to be transmitted to a camera.

FIG. 11 illustrates an example of a camera-to-be-set selection screen.

FIG. 12 illustrates an example of a data structure for managing the setting status of image capture recipes.

FIG. 13 is a flowchart illustrating an example of a process for transmitting an image capture recipe selected by a user to a camera.

FIG. 14 is a flowchart illustrating an example of a process for an image capture recipe search to be performed additionally.

FIG. 15 is a flowchart illustrating an example of a process for rearranging and displaying image capture recipes found as a result of searching.

FIG. 16 illustrates an example of an image capture recipe list screen displaying image capture recipes and having a search function.

### DESCRIPTION OF THE EMBODIMENTS

The following is an example of a detailed description of embodiments according to the disclosure with reference to the drawings. Note that constructional elements described in these embodiments are examples only and are not intended to limit the scope of the disclosure to them alone. In each drawing, the same configurations are, in principle, assigned the same reference number, and redundant descriptions are omitted. In the description of screen examples, screen operations performed by a user is performed at the user's terminal.

In the following embodiments, an “image capture recipe” (also referred to as “sample content”) is a general term for an image capturing method performed by and settings of an image capturing device (hereinafter referred to as a “camera”). By referring to image capture recipes from, for example, professional photographers, even beginners can take similar pictures. In the following embodiments, an image capture recipe may include image capturing setting values, development setting values, recommended subjects, sample images, etc. Image capturing setting values are setting items used when capturing images using a camera. Examples of the image capturing setting values include ISO sensitivity, shutter speed, aperture value, focal length, and white balance used when capturing sample images. Examples of the development setting values include sharpness, contrast, color saturation, and color tone used when developing images captured using a camera. Recommended subjects are subjects that are recommended to be captured using the various image capturing setting values and developed using the various development setting values. Sample images are images captured using the camera for which the various image capturing setting values and various development setting values are set as described above. Note that the setting items corresponding to the image capturing setting values and development setting values are merely examples and are not intended to limit the scope of the disclosure.

### First Embodiment

### System Configuration

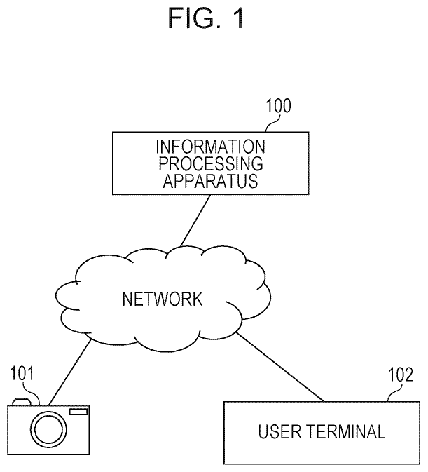

FIG. 1 illustrates an example of the configuration of an information processing system according to the embodiment. An information processing apparatus 100 is connected to one or more image capturing devices 101 and a user terminal 102 via a network.

The information processing apparatus 100 receives device information that identifies the cameras and lenses from the image capturing devices 101. Furthermore, the information processing apparatus 100 receives images captured by the image capturing devices 101. The information processing apparatus 100 transmits image capturing setting values and development setting values managed by the information processing apparatus 100 to the image capturing devices 101. Details of the image capturing setting values and development setting values will be described below.

Each image capturing device 101 takes pictures. The image capturing device 101 also operates in coordination with the information processing apparatus 100 to transmit and receive various types of data to and from each other.

The user terminal 102 displays a screen based on information received from the information processing apparatus 100. By the user operating the screen displayed on the user terminal 102, various types of data and operation instructions are transmitted to the information processing apparatus 100. For convenience of explanation, the configuration is made using the user terminal 102, but the screen displayed on the user terminal 102 may be displayed on the image capturing device 101 and user operations may be performed through the image capturing device 101.

### Hardware Configuration

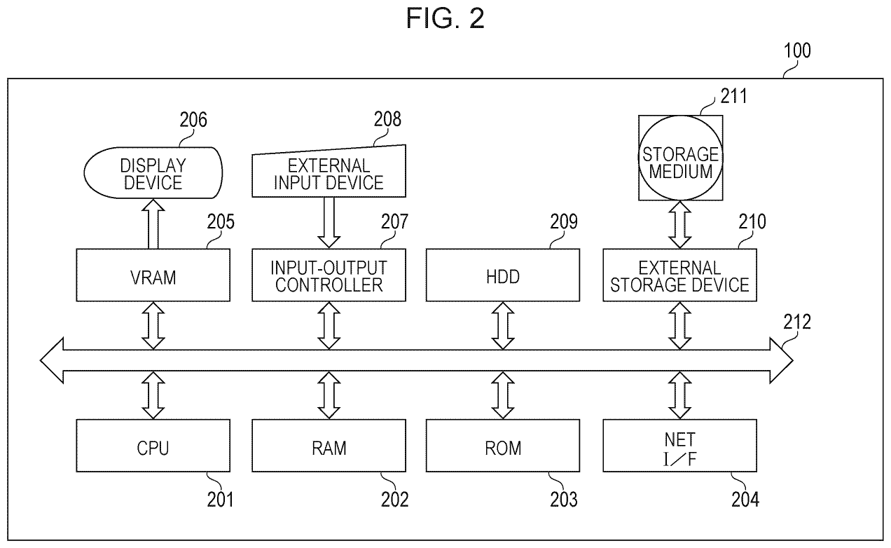

FIG. 2 illustrates an example of the hardware configuration of the information processing apparatus 100.

In FIG. 2, a central processing unit (CPU) 201 controls arithmetic operations performed in each process and controls each processing unit.

A random access memory (RAM) 202 serves as a main memory of the CPU 201 and is used as a region into which execution programs are loaded and as a data region.

A read-only memory (ROM) 203 is a memory that stores operation processing procedures of the CPU 201. The ROM 203 has a region in which the operating system (OS) is recorded that is the system program for controlling devices of the information processing apparatus 100, and a region in which, for example, information necessary for operating the system is recorded. Moreover, for example, a hard disk drive (HDD) 209 to be described below, a NAND flash memory, an SD card, or a solid state drive (SSD) may be used instead of the ROM 203.

A network interface (NET I/F) 204 is a network interface and communicates with the image capturing devices 101 and the user terminal 102 via the network.

A video RAM (VRAM) 205 controls display on the screen of a display device 206, which indicates the operating status of the information processing apparatus 100.

The display device 206 is a display apparatus such as a display.

An input-output controller 207 controls input signals from external input devices 208. Each external input device 208 accepts operations performed by the operator. Examples of the external input device 208 include pointing devices such as a mouse and input devices such as a touch panel display in addition to a keyboard.

A hard disk drive (HDD) 209 is used as a memory region for storing applications and various data. Instead of the HDD, a NAND flash memory, an SD card, a solid state drive (SSD), etc., may be used.

An external storage device 210 is used for reading from the media of the applications described above, for example. Examples of the external storage device 210 include a floppy disk drive as well as a CD-ROM drive, a removable disk such as an SD card.

A storage medium 211 is a magnetic recording medium such as a floppy disk that is read by the external storage device 210. The storage medium 211 is not limited to a magnetic recording medium and may also be a removable data recording device (a removable medium) such as an optical recording medium (for example, a CD-ROM), a magneto-optical recording medium (for example, a magneto-optical disk (MO)), or a semiconductor recording medium (for example, an SD card). Note that applications and data stored in the HDD 209 can be stored in the storage medium 211 and read and used by the external storage device 210.

A transmission bus 212 is a path for data exchange between the devices.

### Application Configuration

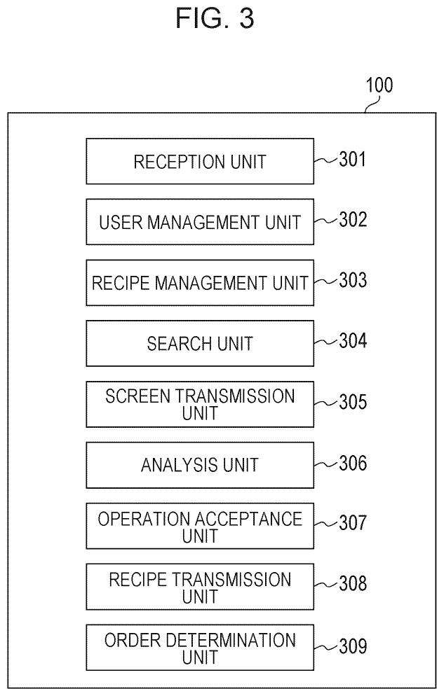

FIG. 3 illustrates an example of the configuration of an application executed on the information processing apparatus 100. In the embodiment, groups of processing modules that operate in the information processing apparatus 100 are stored in the HDD 209 or the storage medium 211. The control and information flow between each group of processing modules and the storage device will be described below.

As illustrated in FIG. 3, the information processing apparatus 100 includes processing modules 301 to 309. These processing modules are modules that are read from the ROM 203, the HDD 209, or the external storage device 210, loaded into the RAM 202, and run as part of an application or program used by the CPU 201.

The processing modules 301 to 309 illustrated in FIG. 3 transmit instruction content to the CPU 201 after automatic startup or in response to instructions input through the external input device 208 by the operator. The CPU 201 acquires programs corresponding to the processing modules based on the instruction content from, for example, the ROM 203, the HDD 209, the external storage device 210, or the RAM 202. The CPU 201 loads the programs into the RAM 202 to perform processing. The CPU 201 writes calculation results into the RAM 202, the HDD 209, the external storage device 210, etc. Moreover, the CPU 201 displays the calculation results on the display device 206 via the VRAM 205 as needed. Through the operation as described above, processing is performed in accordance with each processing module. Note that data transfer between the CPU 201, the RAM 202, the ROM 203, the NET I/F 204, the VRAM 205, the input-output controller 207, the HDD 209, and the external storage device 210 is performed through the transmission bus 212.

A reception unit 301 receives model information (identification information) for identifying the cameras and lenses transmitted from the image capturing devices 101 and images captured by the cameras. In the exemplary embodiment, camera names and lens names are used as model information for identification.

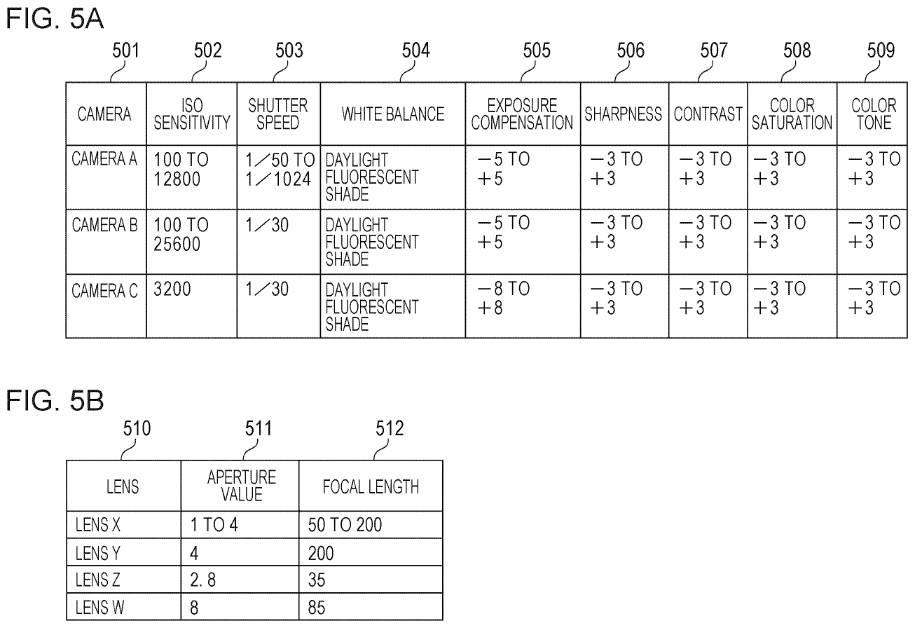

A user management unit 302 associates the model information and images received by the reception unit 301 with the users to perform management. Moreover, the user management unit 302 associates the subjects of the images analyzed by an analysis unit 306 that is to be described below with the users to perform management. Furthermore, the user management unit 302 manages cameras for which image capture recipes selected by the users and accepted by an operation acceptance unit 307 that is to be described below and setting values for the image capture recipes are to be set. A data structure for managing each data will be described using FIGS. 5A to 7 and 12.

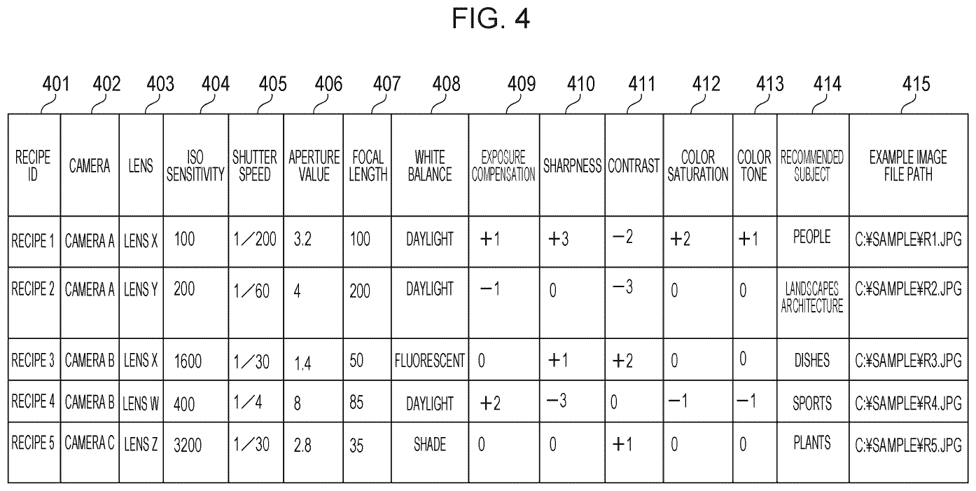

A recipe management unit 303 manages image capture recipes (also referred to as “sample content”) to be provided to users. The image capture recipes are prepared by professional photographers, for example, and registered in advance by the system administrator of the information processing apparatus 100. The system may also be configured to ask users of the system to provide image capture recipes that the users using the system have created. The data structure for managing image capture recipes will be described below using FIG. 4.

A search unit 304 searches the image capture recipes managed by the recipe management unit 303.

A screen transmission unit 305 transmits, to the user terminal 102, individual screens, such as an image capture recipe list screen 900, an image capture recipe details screen 910, and a camera-to-be-set selection screen 1100 that are to be described below. The user terminal 102 displays the received individual screens.

The analysis unit 306 analyzes images received by the reception unit 301 to extract subjects.

The operation acceptance unit 307 accepts information input by the user operating each screen. Examples of the screen include the image capture recipe list screen 900, the image capture recipe details screen 910, and the camera-to-be-set selection screen 1100.

A recipe transmission unit 308 transmits an image capture recipe determined on the image capture recipe details screen 910 to the image capturing device 101. In a case where the image capturing device 101 is switched off, the image capture recipe is transmitted when the image capturing devices 101 is switched on and a connection is established.

The information processing apparatus 100 can detect the power status of the image capturing device 101 by receiving, from the image capturing device 101, information regarding the transition of the power status of the image capturing device 101. For example, the information processing apparatus 100 may receive, from the image capturing device 101, a signal indicating that the image capturing device 101 has entered the power ON state from the power OFF state. In addition, the information processing apparatus 100 may receive, from the image capturing device 101, a signal indicating that the image capturing device 101 will shift from the power ON state to the power OFF state. In this manner, the information processing apparatus 100 can detect the power status of the image capturing device 101.

Alternatively, the recipe transmission unit 308 may determine the timing of image capture recipe transmission, based on the communication connection status of the information processing apparatus 100. That is, after an image capture recipe to be transmitted to the image capturing device 101 is determined, the recipe transmission unit 308 may transmit the image capture recipe to the image capturing device 101, based on the communication connection established between the image capturing device 101 and the information processing apparatus 100. Alternatively, in a case where the image capturing device 101 is connected to the information processing apparatus 100 and where an instruction to transmit the image capture recipe to the image capturing device 101 is received from the user, the recipe transmission unit 308 may transmit the image capture recipe.

An order determination unit 309 determines the order of image capture recipes to be displayed on the image capture recipe list screen 900.

### Processing performed by Information Processing Apparatus 100

Next, the process flow performed by the information processing apparatus 100 will be described using FIGS. 4 to 13.

FIG. 4 illustrates an example of a data structure for managing image capture recipes. The image capture recipes managed by the recipe management unit 303 are registered in advance in this data structure by the system administrator of the information processing apparatus 100.

Recipe ID 401 indicates identification (ID) information for uniquely identifying image capture recipes. Each time an image capture recipe is registered in this data structure, a unique ID is assigned.

Camera 402 indicates the names of cameras used to capture example images corresponding to the image capture recipes. Lens 403 indicates the names of lenses used to capture the example images corresponding to the image capture recipes.

ISO sensitivity 404 indicates setting values for ISO sensitivity items set for the image capturing devices when capturing the example images. Shutter speed 405 indicates setting values for shutter speed items set for the image capturing devices when capturing the example images. Aperture value 406 indicates setting values for aperture value items set for the image capturing devices when capturing the example images. Focal length 407 indicates setting values for focal length items set for the image capturing devices when capturing the example images. White balance 408 indicates setting values for white balance items set for the image capturing devices when capturing the example images. Exposure compensation 409 indicates setting values for exposure compensation items set for the image capturing devices when capturing the example images. Sharpness 410 indicates setting values for sharpness items set for the image capturing devices when capturing the example images. Contrast 411 indicates setting values for contrast items set for the image capturing devices when capturing the example images. Color saturation 412 indicates setting values for color saturation items set for the image capturing devices when capturing the example images. Color tone 413 indicates setting values for color tone items set for the image capturing devices when capturing the example images.

Recommended subject 414 indicates recommended subjects in a case where image capturing and development are performed using individual settings.

Example image file path 415 indicates file paths to storage locations where the example images are stored. Each file path may be the path to the HDD 209 or that to the storage medium 211 of the information processing apparatus 100. Alternatively, each file path may be the path to an external storage if access to the file is possible although such a configuration is not used in the exemplary embodiment.

FIG. 5A illustrates an example of a data structure for managing information regarding cameras that can communicate with the information processing apparatus 100. FIG. 5B illustrates an example of a data structure for managing information regarding lenses that can communicate with the information processing apparatus 100. These data structures are used to manage settable values for camera setting items and lens setting items. The data of these data structures is registered in advance by the system administrator of the information processing apparatus 100.

FIG. 5A illustrates a data structure (for example, a table) indicating a range of setting values that are settable for each camera model.

Camera field 501 indicates the names of cameras. In the exemplary embodiment, the name of each camera is assumed to be uniquely identifiable without duplication.

ISO sensitivity field 502 indicates settable values for ISO sensitivity items of the cameras. Shutter speed field 503 indicates settable values for shutter speed items of the cameras. White balance field 504 indicates settable values for white balance items of the cameras. Exposure compensation field 505 indicates settable values for exposure compensation items of the cameras. Sharpness field 506 indicates settable values for sharpness items of the cameras. Contrast field 507 indicates settable values for contrast items of the cameras. Color saturation field 508 indicates settable values for color saturation items of the cameras. Color tone field 509 indicates settable values for color tone items of the cameras.

FIG. 5B illustrates a data structure (for example, a table) for managing lens setting items.

Lens field 510 indicates the names of lenses. In the exemplary embodiment, assume that the name of each lens is assumed to be uniquely identifiable without duplication. Aperture value field 511 indicates settable values as the aperture values of the lenses. Focal length field 512 indicates settable values as the focal lengths of the lenses.

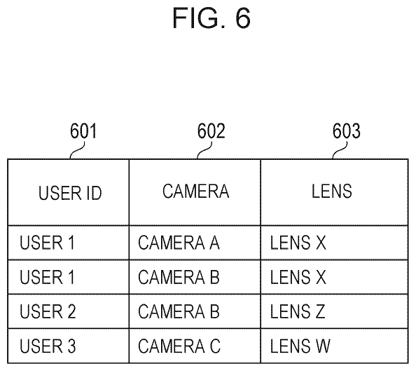

FIG. 6 illustrates an example of a data structure (for example, a table) for associating the identification information of users and the identification information of cameras and lenses with each other for management. The information processing apparatus 100 associates the camera names and lens names transmitted from the image capturing devices 101 and received by the reception unit 301 with the identification information of the users to perform management.

User ID field 601 indicates identification (ID) information that uniquely identifies the users. Camera field 602 indicates the names of the users' cameras. Lens field 603 indicates the names of the lenses attached to the cameras at the time of image capturing. By referring to this data structure, based on a value in the user ID field 601, the model of the camera and the type of lens used by the user indicated by the corresponding user ID can be uniquely identified.

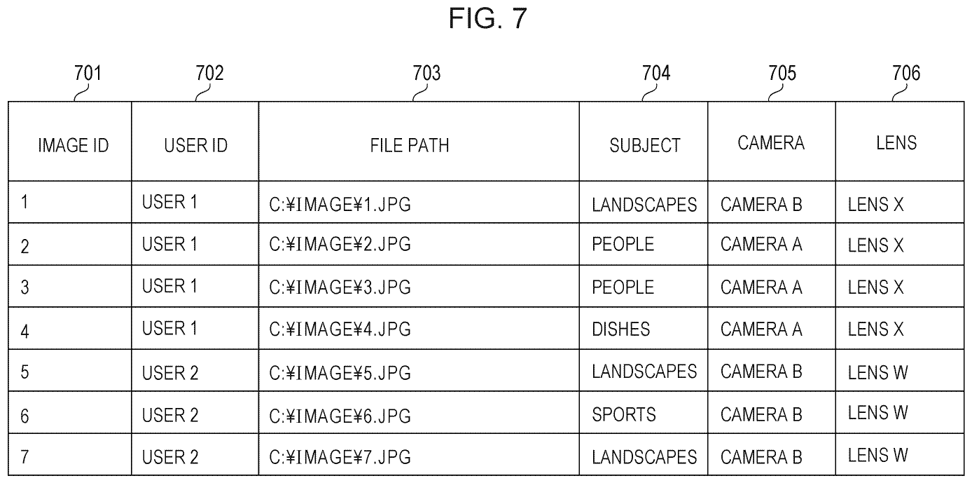

FIG. 7 illustrates an example of a data structure (for example, a table) for managing images taken by the users. The data structure is used to manage images transmitted from the image capturing devices 101 and received by the reception unit 301.

Image ID field 701 indicates IDs that uniquely identify the images. User ID field 702 indicates the IDs of the users. File path field 703 indicates the file paths of storage locations where the images are stored. Each file path may be the path to the HDD 209 or that to the storage medium 211 of the information processing apparatus 100. Alternatively, each file path may be the path to an external storage if access to the file is possible. Subject field 704 indicates the subjects of the images. The subject field 704 is used to manage subjects extracted by the analysis unit 306 analyzing the images. Camera field 705 indicates the names of cameras used in image capturing. Lens field 706 indicates the names of lenses used in image capturing.

The table in FIG. 7 makes it possible to identify information indicating the number of images captured using a first combination of an image capturing device and a lens and information indicating the number of images captured using a second combination of an image capturing device and a lens. In addition to the table in FIG. 7, the information indicating the number of images captured using the second combination of the image capturing device and the lens may be retained in the HDD 209, the external storage device 210, or the storage medium 211.

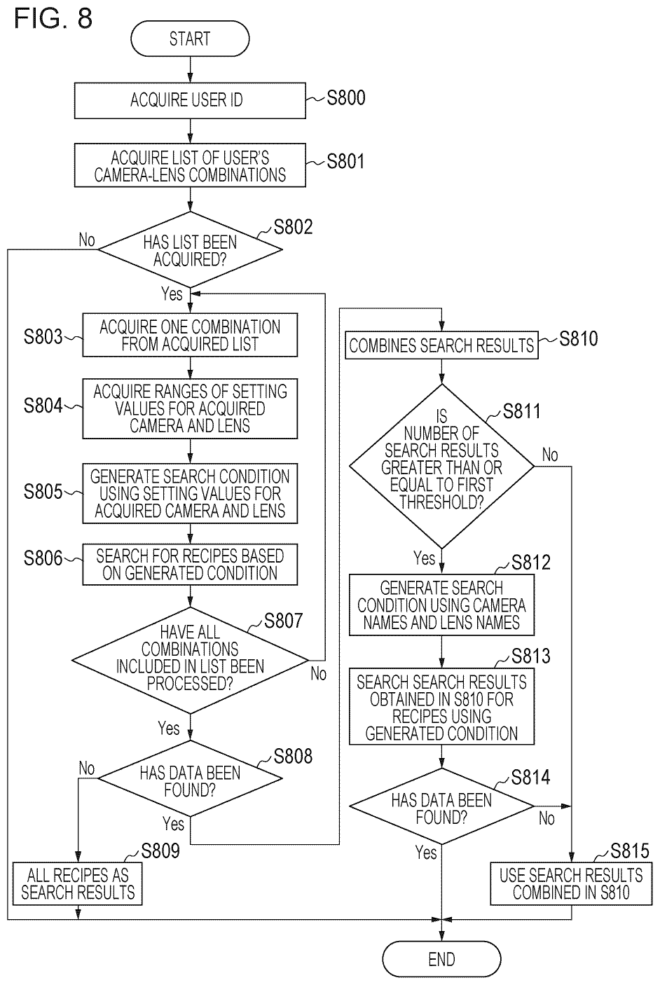

FIG. 8 is a flowchart illustrating an example of a process for searching for image capture recipes. In a case where this flowchart is performed by executing a program, this flowchart is implemented by the CPU 201 executing the program stored in the ROM 203, the HDD 209, the external storage device 210, or the storage medium 211 and loaded into the RAM 202. In the exemplary embodiment, the process illustrated in the flowchart in FIG. 8 is described for an example that is initiated in response to a user accessing the information processing apparatus 100 from the user terminal 102 and opening the image capture recipe list screen 900 to be described below.

In S800, the search unit 304 acquires the identification information of a user who provides an image capture recipe. In S800, the search unit 304 operates as an acceptance unit that accepts the identification information of the user.

For example, the search unit 304 displays, on the display device 206, an input screen for entering the identification information of the user. The search unit 304 acquires the identification information of the user entered through the input screen. When the identification information of the user is acquired, the authentication process of the user may be performed. The information processing apparatus 100 transmits a request for user authentication to a Web server by transmitting the login ID and password entered from the input screen displayed on the display device 206. The Web server notifies the information processing apparatus 100 of the result of the authentication. In a case where the user is authenticated, the information processing apparatus 100 acquires the identification information of the user associated with the login ID to perform the process described in S801 below. In a case where the user is not authenticated, the process of accepting the login ID and password is repeated. The information processing apparatus 100 may acquire the identification information of the user associated with the login ID from the Web server. Alternatively, the information processing apparatus 100 may retain the identification information of the user associated with the login ID. Although the example of using the Web server for authentication is described, the information processing apparatus 100 may have the authentication function.

In S801, the search unit 304 acquires, from the data structure illustrated in FIG. 6, a list of camera-lens combinations owned by the user corresponding to the identification information acquired in S800.

In S802, the search unit 304 determines whether or not the list of camera-lens combinations has been acquired in S801. In a case where the list of camera-lens combinations has been acquired, the process proceeds to S803. In a case where the list of camera-lens combinations has not been acquired, the process ends. Note that the case where the list of camera-lens combinations has not been acquired is, for example, a case where the user's cameras and lenses have not yet been registered.

In S803, the search unit 304 acquires one camera-lens combination acquired in S801.

In S804, the search unit 304 acquires, from the data structure in FIG. 5A, the ranges of setting values settable for the camera included in the combination acquired in S803. Moreover, the search unit 304 acquires, from the data structure in FIG. 5B, the ranges of setting values settable for the lens included in the combination acquired in S803. That is, in S804, the search unit 304 operates as a first acquisition unit that acquires the ranges of setting values settable for the camera (image capturing device). The first acquisition unit acquires, based on the identification information of the user accepted in S800, the ranges of setting values settable for the image capturing device associated with the identification information of the user. Moreover, in S804, the search unit 304 operates as a second acquisition unit that acquires the ranges of setting values settable for the lens. The second acquisition unit acquires, based on the identification information of the user accepted in S800, the ranges of setting values settable for the lens associated with the identification information of the user.

In S805, the search unit 304 generates a search condition using the values for the individual setting items acquired in S804. For example, in a case where the value in the ISO sensitivity field 502 indicates 100 to 12800, a search condition is the ISO sensitivity that falls within this range. Similarly, all the setting items, such as shutter speed and white balance, serve as the condition. Note that each setting item is combined with a logical AND (AND condition).

In S806, the search unit 304 identifies, based on the search condition generated in S805 and the setting values for each recipe illustrated in the data structure in FIG. 4, image capture recipes that satisfy the search condition. In S806, the search unit 304 operates as a search unit that searches the sample content stored in a storage unit for sample content that corresponds to images captured using setting values within the ranges of setting values acquired by the first acquisition unit. In particular, the search unit 304 searches the sample content, based on the ranges of setting values acquired by the first acquisition unit and the ranges of setting values acquired by the second acquisition unit in the exemplary embodiment.

In S807, the search unit 304 determines whether or not all camera-lens combinations included in the list acquired in S801 have been processed. In a case where all camera-lens combinations included in the list acquired in S801 have been processed, the process proceeds to S808. In a case where all camera-lens combinations included in the list acquired in S801 have not been processed, the process proceeds to S803. For the camera-lens combinations that have not been processed, the processing from S803 to S806 are performed.

In S808, the search unit 304 determines whether or not image capture recipes have been found as a result of the search in S806. In a case where multiple searches have been performed, a determination is made based on the results of the multiple searches. In a case where image capture recipes have been found, the process proceeds to S810. In a case where image capture recipes have not been found, the process proceeds to S809.

In S809, since no data has been found, the search unit 304 outputs all recipes as search results and terminates the process. In this manner, in a case where no sample content has been found as a result of the searches using a first condition, the search unit 304 outputs the entire sample content stored in the storage unit.

In S810, the search unit 304 combines the search results. In a case where multiple searches have been performed, the results of the multiple searches are combined except for duplicate results. In a case where only one search has been performed, the result of the single search is used.

In S811, the search unit 304 determines whether the number of search results is greater than or equal to a first threshold.

In a case where the number of search results is greater than or equal to the first threshold (Yes in S811), the process proceeds to S812, and the search results are further narrowed down. In a case where the number of search results is not greater than or equal to the first threshold, the process proceeds to S815. In this case, the first threshold may be set in advance by the system administrator of the information processing apparatus 100 or may be set by the user.

In S812, the search unit 304 generates a search condition based on all combinations of the camera identification information and the lens identification information acquired in S801. In a single camera-lens combination, the camera and the lens are combined with a logical AND (AND condition). In a case where there are multiple camera-lens combinations, the camera-lens combinations are combined with a logical OR (OR condition). For example, regarding a combination of a “camera A” and a “lens X” and a combination of a “camera B” and a “lens Y”, (the “camera A” AND the “lens X”) OR (the “camera B” AND the “lens Y”).

In S813, the search unit 304 searches the search results obtained in S810 for image capture recipes using the condition generated in S812. In this manner, the search unit 304 performs the following search process in a case where the number of pieces of sample content found using a first search condition is greater than or equal to the first threshold. That is, the search unit 304 searches for sample content using a second search condition for searching for sample content that corresponds to images captured using the combinations of the image capturing devices and lenses associated with the identification information of the user.

In S814, the search unit 304 determines whether or not image capture recipes have been found as a result of the search in S813. In a case where image capture recipes have been found, the process ends. In a case where image capture recipes have not been found, the process proceeds to S815. In S814, the determination process as to whether or not image capture recipes have been found is performed, but it may be determined whether or not the number of image capture recipes found is greater than or equal to a second threshold. The second threshold is lower than the first threshold. In a case where the number of image capture recipes found is greater than or equal to the second threshold, the search result is output, and the process ends. In a case where the number of image capture recipes found is less than the second threshold, the process proceeds to S815.

In S815, the search unit 304 outputs the search results combined in S810 as the image capture recipe search result and the process ends. In this manner, in a case where the number of pieces of sample content found using the second search condition is greater than or equal to the second threshold, the search unit 304 outputs the sample content found using the second search condition as the search result. In a case where the number of pieces of sample content found using the second search condition is less than the second threshold, the search unit 304 outputs the sample content found using the first search condition as the search result.

In the process described above, a search for image capture recipes is performed based on the setting values settable for the cameras associated with the user. Thus, image capture recipes corresponding to images captured by different cameras from the cameras associated with the user can also be output as the search result. Thus, compared with searching by camera name, a wider range of image capture recipe options can be provided to the user. The same is true for lenses.

In the process described above, first, a search for image capture recipes is performed using the first search condition (the search condition generated in S805). Next, in a case where the number of search results found using the first search condition is greater than or equal to a certain threshold, the image capture recipes are narrowed down using the second search condition (the search condition generated in S812). In this manner, it is possible to prevent the number of search results presented to the user from becoming too large. Moreover, in a case where the number of search results found using the first search condition is less than the certain threshold, the search results are not narrowed down using the second search condition. Thus, it is possible to prevent the number of search results presented to the user from becoming too small.

In the above embodiment, the example has been described in which the search conditions are generated based on both the setting values settable for cameras and the setting values settable for lenses; however, this is not the only example. Searches may be performed based only on the ranges of setting values settable for the cameras associated with the ID of the user.

Alternatively, searches may be performed based only on the ranges of setting values settable for the lenses associated with the ID of the user. The user may be allowed to select through the image capture recipe list screen 900 whether searches are to be performed based on the camera-lens combinations or based only on the setting values settable for the cameras or those for the lenses.

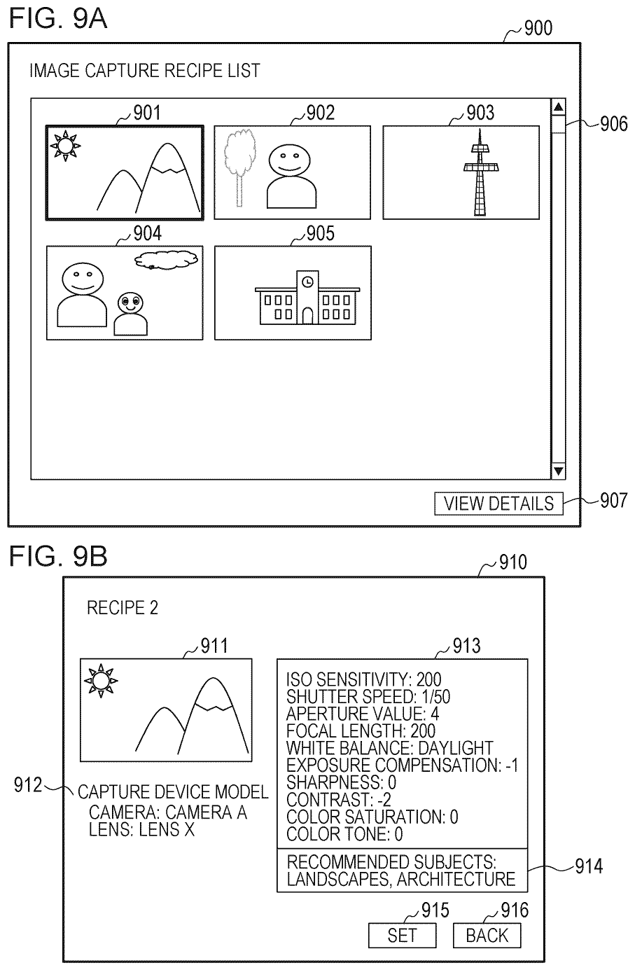

FIG. 9A illustrates an example of the image capture recipe list screen 900 that lists image capture recipes as search results. After the process in FIG. 8 ends, the screen transmission unit 305 acquires example images based on the image capture recipes found by the search unit 304. Thereafter, the screen transmission unit 305 generates a screen and transmits the screen to the user terminal 102. The screen transmission unit 305 operates as an output unit that outputs the search results.

Example images 901 to 905 are example images of image capture recipes found through the process in FIG. 8. The example images of the image capture recipes found through the process in FIG. 8 are acquired from, for example, the HDD 209 and displayed. In this case, the example image 901 is displayed in a highlighted manner, which indicates the state where it is selected by the user.

A scroll bar 906 is a scroll bar. In a case where there is an example image of an image capture recipe that cannot fit in the display region of the screen when displayed, the scroll bar is displayed. By operating the scroll bar, the portion of the example image outside the display region of the screen can be displayed.

A View Details button 907 is a button for the user to determine the image capture recipe that they want to check. When the user presses the View Details button 907, the operation acceptance unit 307 accepts information regarding the example image of the selected image capture recipe. The screen transmission unit 305 acquires, based on the information regarding the example image of the accepted image capture recipe, the information regarding the image capture recipe from the data structure in FIG. 4. Furthermore, the screen transmission unit 305 generates the image capture recipe details screen 910, which will be described below, and then transmits the screen to the user terminal 102.

FIG. 9B illustrates an example of the image capture recipe details screen 910 that displays details of an image capture recipe.

The image capture recipe details screen 910 displays information regarding the image capture recipe selected through the image capture recipe list screen 900.

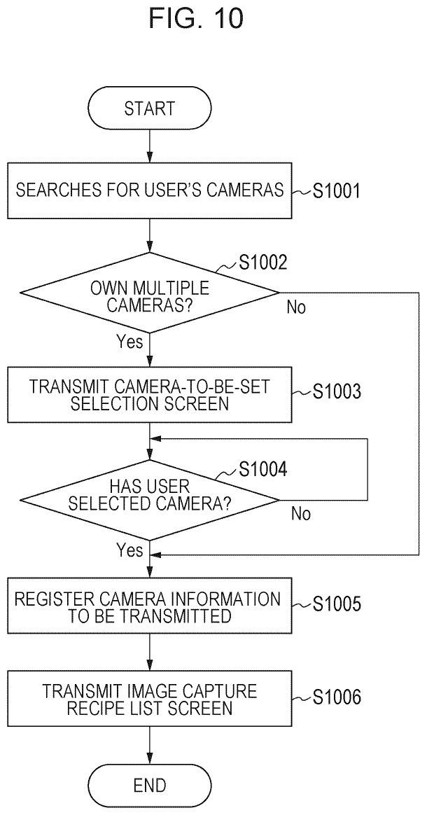

An example image 911 is an example image of an image capture recipe. A capture device model 912 indicates the name of the camera and the name of the lens used to capture the example image 911. Setting values 913 are individual setting values for the camera and lens used to capture the example image 911. Recommended subjects 914 indicate recommended subjects for a case where images are captured with the individual setting values 913. A Set button 915 is a confirmation button for setting, in the user's camera, the individual setting values displayed in the setting values 913. When the user operates the Set button 915, the operation acceptance unit 307 receives, from the user terminal 102, information indicating that the image capture recipe displayed on the image capture recipe details screen 910 has been selected. Furthermore, the process in FIG. 10 to be described below is performed. A Back button 916 is a button for transitioning the screen back to the image capture recipe list screen 900. The image capture recipe list screen 900 is transmitted to the user terminal 102 again.

FIG. 10 is a flowchart illustrating an example of a process for determining transmission of an image capture recipe selected by the user to the user's camera. The process is triggered by the user pressing the Set button 915.

In S1001, the recipe transmission unit 308 searches the data structure in FIG. 6 to acquire the identification information of cameras associated with the user.

In S1002, the recipe transmission unit 308 determines whether or not the user owns multiple cameras. In a case where the user owns multiple cameras, the process proceeds to S1003. In a case where the user does not own multiple cameras, the process proceeds to S1005.

In S1003, the screen transmission unit 305 transmits, to the user terminal 102, a camera-to-be-set selection screen 1100 to be described below.

In S1004, the operation acceptance unit 307 determines whether or not the user has selected a camera by operating the camera-to-be-set selection screen 1100. A determination is repeatedly performed until a camera is selected. If a camera is selected, the process proceeds to S1005.

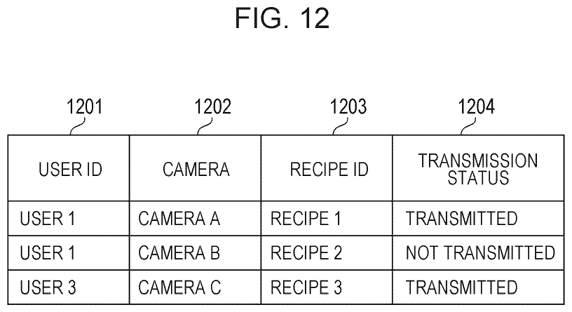

In S1005, the recipe transmission unit 308 registers, based on the selection result, camera information to be transmitted to a data structure in FIG. 12, which is described below, and the process ends.

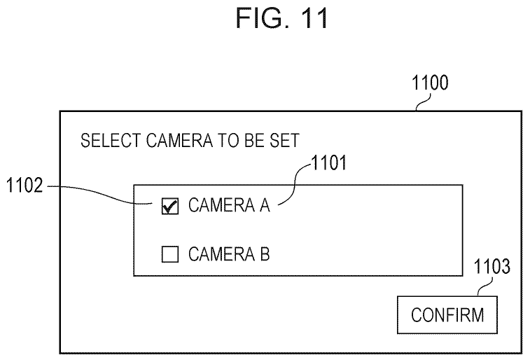

FIG. 11 illustrates an example of the camera-to-be-set selection screen 1100 displayed in a case where a user owns multiple cameras. Through the process in FIG. 10, the camera for which an image capture recipe is to be set is managed.

An owned camera 1101 indicates cameras owned by the user. In a case where multiple cameras are owned by the user, the cameras are listed.

A selection checkbox 1102 indicates checkboxes for selecting a camera to be set. In a case where there are multiple cameras, multiple checkboxes are displayed. In a display example of the camera-to-be-set selection screen 1100, a “camera A” is selected.

A Confirm button 1103 is a button for the user to confirm the selection of the camera. When the user operates the Confirm button 1103, the operation acceptance unit 307 receives, from the user terminal 102, information regarding the camera selected through the camera-to-be-set selection screen 1100. In the process in FIG. 10, a determination of Yes is made in the processing in S1004, and the process proceeds to S1005.

FIG. 12 illustrates an example of a data structure for managing the setting status of image capture recipes.

A user ID field 1201 indicates the IDs of users. A camera field 1202 indicates the names of cameras for which the individual setting values for the image capture recipes are to be set or have already been set. A recipe ID field 1203 indicates the image capture recipes to be set for the cameras. A transmission status field 1204 indicates the status of transmission to the cameras. “Transmitted” indicates that the individual setting values of a corresponding image capture recipe have been transmitted to the corresponding camera. “Not transmitted” indicates that the individual setting values of a corresponding image capture recipe have not yet been transmitted to the corresponding camera. Immediately after data is registered in this data structure, “not transmitted” is registered for the data.

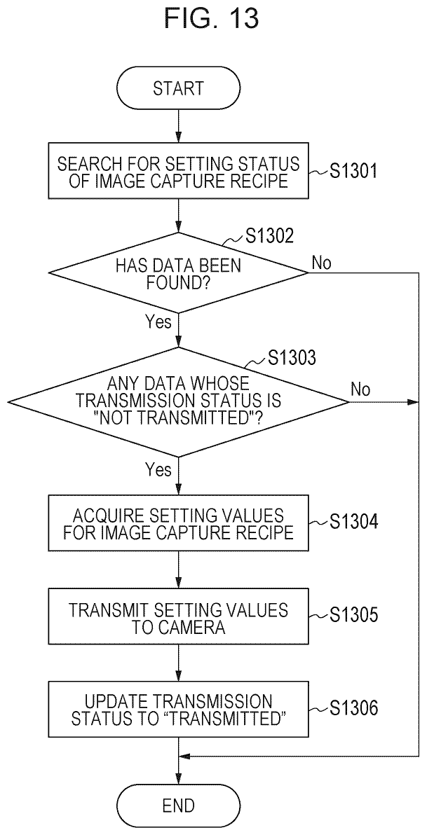

The process for updating the transmission status to “transmitted” will be described below using FIG. 13.

In this data structure, a combination of a value in the camera field 1202 and a value in the recipe ID field 1203 associated with a certain value in the user ID field 1201 can be uniquely identified.

FIG. 13 is a flowchart illustrating an example of a process for transmitting individual setting values for an image capture recipe selected by a user to a camera of the user. The process is triggered when the user's camera is connected to the information processing apparatus 100.

In S1301, the recipe transmission unit 308 uses the user ID and the name of a connected camera to search the data structure in FIG. 12 for the corresponding data.

In S1302, the recipe transmission unit 308 determines whether or not the corresponding data has been found in S1301. In a case where the corresponding data has been found, the process proceeds to S1303. In a case where the corresponding data has not been found, the process ends.

In S1303, the recipe transmission unit 308 determines whether or not the data found in S1301 contains data whose transmission status 1204 is “not transmitted”. In a case where the data found in S1301 contains such data, the process proceeds to S1304. In a case where the data found in S1301 does not contain such data, the process ends.

In S1304, the recipe transmission unit 308 uses the recipe ID in the recipe ID column 1203 acquired in S1301 to search the data structure in FIG. 4 to acquire individual setting values.

In S1305, the recipe transmission unit 308 transmits the individual setting values to the connected camera.

In S1306, the recipe transmission unit 308 updates the transmission status 1204 of the data found in S1301 to “transmitted”, and then the process ends.

The camera sets the individual received setting values.

In the exemplary embodiment, a search for image capture recipes is performed based on setting values settable for a camera associated with the user. Thus, image capture recipes corresponding to images captured by different cameras from the camera associated with the user can also be output as the search result. Thus, compared with searching by camera name, a wider range of image capture recipe options can be provided to the user.

The same applies to lenses. A search for image capture recipes is performed based on setting values settable for a lens associated with the user. Thus, image capture recipes corresponding to images captured by different cameras from the camera associated with the user can also be output as the search result. Thus, compared with searching by lens name, a wider range of image capture recipe options can be provided to the user.

In the exemplary embodiment, first, a search for image capture recipes is performed using the first search condition (the search condition generated in S805). Next, in a case where the number of search results found using the first search condition is greater than or equal to a certain threshold, the image capture recipes are narrowed down using the second search condition (the search condition generated in S812). In this manner, it is possible to prevent the number of search results presented to the user from becoming too large. Moreover, in a case where the number of search results found using the first search condition is less than the certain threshold, the search results are not narrowed down using the second search condition. Thus, it is possible to prevent the number of search results presented to the user from becoming too small.

### Second Embodiment

In a second embodiment, an example will be described in which subject information is also used to search for image capture recipes.

The configuration of the system according to the embodiment is substantially the same as that described in the first embodiment, and thus the description will be omitted.

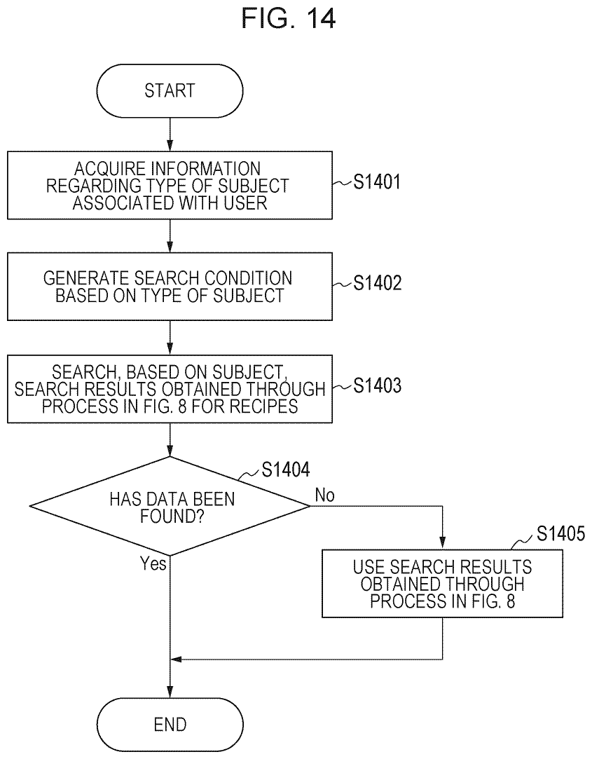

FIG. 14 illustrates a flowchart indicating an example in which subject information is also used to perform the search process after the search process described using FIG. 8 is performed. In the embodiment, in a case where the number of image capture recipes found in FIG. 8 is greater than or equal to a predetermined threshold, the process illustrated in FIG. 14 is performed to further narrow down the number of image capture recipes.

In S1401, the search unit 304 acquires, from the data structure in FIG. 7, information indicating the type of subject associated with the user operating the image capture recipe details screen 910.

In S1402, the search unit 304 generates a search condition for searching for image capture recipes associated with the type of subject acquired in S1401. In a case where multiple types of subject associated with the user are acquired, the multiple types of subject are combined with a logical OR (OR condition).

In S1403, the search unit 304 searches the search results in FIG. 8 for image capture recipes using the condition generated in S1402.

In S1404, the search unit 304 determines whether or not image capture recipes have been found as a result of the search in S1403. In a case where image capture recipes have been found, the process ends. In a case where image capture recipes have not been found, the process proceeds to S1405.

In S1405, the search unit 304 treats the search results obtained before searches are conducted using the type(s) of subject (that is, the search results obtained through the process in FIG. 8) as the results of image capture recipe searches, and the process ends.

As described above, according to the embodiment, as a result of the process in FIG. 8, in a case where many image capture recipes are found, the number of image capture recipes can be limited by performing an additional subject-based search. Thus, it will be easier for the user to find their favorite image capture recipe. Note that, in the description of S1402, the case has been described in which the search condition is generated by combining the multiple subjects with a logical AND. However, it is sufficient that only the most common subject be acquired in S1401 to limit the number of image capture recipes to be found.

### Third Embodiment

In a third embodiment, a process will be described in which the image capture recipes that are the search results described in the first or second embodiment are reordered and displayed in order to allow the user to easily find their favorite image capture recipe.

The configuration of the system according to the embodiment is substantially the same as that described in the first embodiment, and thus the description will be omitted.

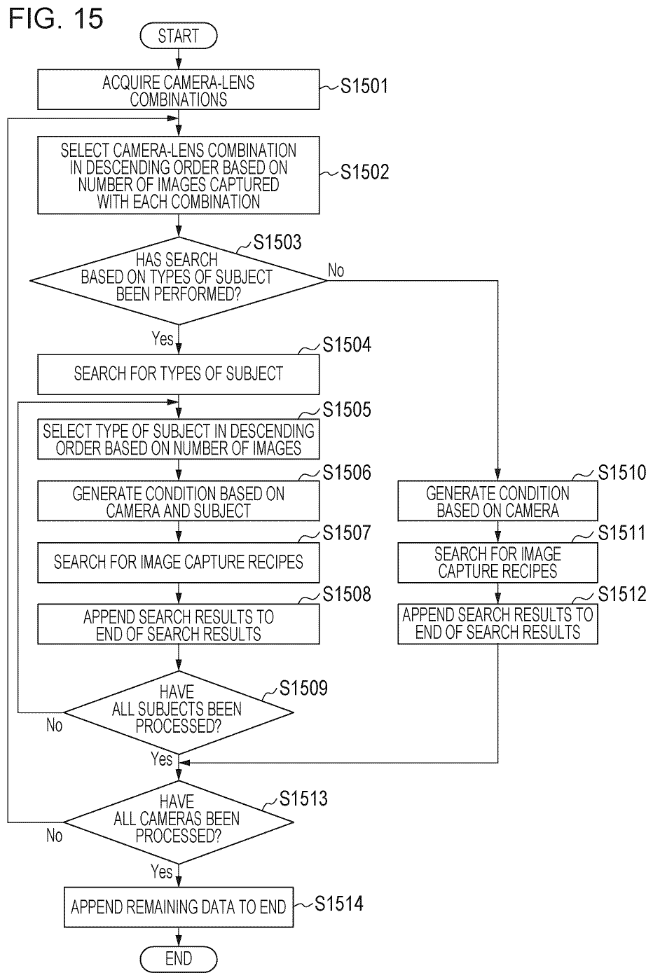

FIG. 15 is a flowchart illustrating an example of a process for prioritizing and reordering image capture recipes when the image capture recipe list screen 900 is configured to be transmitted to the user terminal 102. Reordering is performed after the search process described using FIG. 8 or 14 ends.

In S1501, the order determination unit 309 refers to the data structure in FIG. 7 to acquire camera-lens combination information associated with the user identified in S800.

In S1502, the order determination unit 309 selects, among the camera-lens combinations indicated by the combination information acquired in S1501, a camera-lens combination in descending order based on the number of images captured with each combination. Each time the processing in S1502 is repeated, the order determination unit 309 selects the combination with the largest number of captured images among the unselected combinations.

In S1503, the order determination unit 309 determines whether or not the search based on the types of subject described using FIG. 14 has been performed. In a case where such a search has been performed, the process proceeds to S1504. In a case where such a search has not been performed, the process proceeds to S1510.

In S1504, the order determination unit 309 acquires, using the data structure in FIG. 7, information regarding the types of subject associated with the user identified in S800.

In S1505, the order determination unit 309 selects a type of subject in descending order based on the number of images associated with each type of subject acquired in S1504. Each time the processing in S1504 is repeated, the order determination unit 309 selects, among the unselected types of subject, a type of subject in descending order based on the number of images in which each unselected subject type appears.

In S1506, the order determination unit 309 generates a search condition for searching for image capture recipes including the camera-lens combination selected in S1502 and the type of subject selected in S1505. The camera and lens and the subject are combined with a logical AND (AND condition).

In S1507, the order determination unit 309 searches the search results obtained from the search process in FIG. 14.

In S1508, the order determination unit 309 appends the search results found in S1507 to the end of the search results found so far. If the search in S1507 is the first search, the results obtained in S1507 are used as they are. If the search in S1507 is the second or subsequent search, the current search results are appended to the end of the previously combined search results, namely those from the last search.

In S1509, the order determination unit 309 determines whether or not all the types of subject found in S1504 have been processed. In a case where all the types of subject found in S1504 have been processed, the process proceeds to S1513. In a case where all the types of subject found in S1504 have not been processed, the process proceeds to S1505.

In S1510, the order determination unit 309 generates a search condition based on the camera and lens acquired in S1502. The camera and the lens are combined with a logical AND (AND condition).

In S1511, the order determination unit 309 searches the search results acquired in FIG. 8.

In S1512, the order determination unit 309 appends the search results found in S1511 to the end of the search results found so far. If the search in S1511 is the first search, the results obtained in S1511 are used as they are. If the search in S1511 is the second or subsequent search, the current search results are appended to the end of the previously combined search results, namely those from the last search.

In S1513, the order determination unit 309 determines whether or not all the camera-lens combinations acquired in S1501 have been processed. In a case where all the camera-lens combinations acquired in S1501 have been processed, the process proceeds to S1514. In a case where all the camera-lens combinations acquired in S1501 have not been processed, the process proceeds to S1502.

The order determination unit 309 searches the search results obtained in FIG. 14 in S1507 and searches the search results obtained in FIG. 8 in S1511; however, in S1514, if any data remains unselected, the order determination unit 309 appends the data to the end of the final result obtained in S1508 or S1512.

In this manner, the following process is performed in a case where the number of images captured using a first camera-and-lens combination is greater than the number of images captured using a second camera-and-lens combination. That is, the above search results are output such that the sample content corresponding to the images captured using the first combination is displayed on the display screen with priority over the sample content corresponding to the images captured using the second combination.

According to the embodiment as described above, the image capture recipes corresponding to the camera-lens combinations and types of subjects for which the numbers of captured images are large are placed higher among the search results obtained in FIG. 14, and the image capture recipes corresponding to the camera-lens combinations for which the numbers of captured images are large are placed higher among the search results obtained in FIG. 8.

In this manner, it becomes easier for the user to find image capture recipes that are expected to have higher priority.

### Fourth Embodiment

In a fourth embodiment, an exemplary embodiment of an image capture recipe list screen different from the image capture recipe list screen 900 described using FIG. 9 will be described.

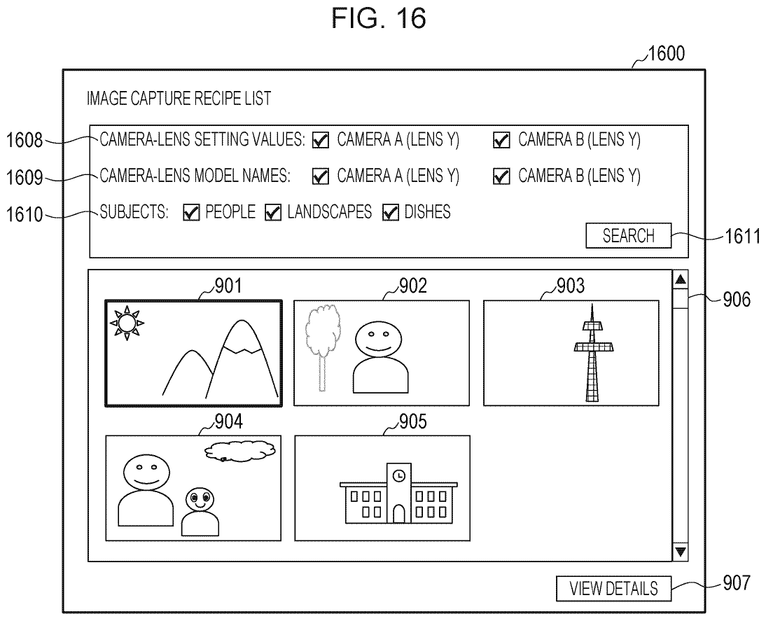

FIG. 16 illustrates an example of an image capture recipe list screen 1600 with a search function. The image capture recipe list screen 1600 lists image capture recipe search results. After the process in FIG. 8 or 14 ends, the screen transmission unit 305 acquires example images from the image capture recipes found by the search unit 304 and then generates a screen and transmits the screen to the user terminal 102.

The example images 901 to 905, the scroll bar 906, the View Details button 907 are as described above using FIG. 9.

A setting value 1608 indicates camera-lens setting values specified when the search is performed in FIG. 8 or 14. When camera-lens setting values are specified as search conditions, the corresponding checkboxes are checked.

A model name 1609 indicates camera-lens model names specified when the search is performed in FIG. 8 or 14. When camera-lens model names are specified as search conditions, the corresponding checkboxes are checked.

A subject 1610 indicates subjects specified when the search is performed in FIG. 8 or 14. When subjects are specified as search conditions, the corresponding checkboxes are checked.

A Search button 1611 performs a search again using the conditions set in the setting value 1608, the model name 1609, and the subject 1610. The example images 901 to 905 are deleted once a new search is performed, and example images corresponding to newly found image capture recipes are displayed.

According to the embodiment as described above, since new searches can be performed using conditions specified by the user, it becomes easier to find their favorite image capture recipe although more effort may be required than performing searches automatically in FIG. 8 or 14. Note that either one of the image capture recipe list screen 900 or the image capture recipe list screen 1600 with the search function may be used, or it is acceptable to use these screens selectively depending on the conditions. For example, in a case where the appropriate number of results is not obtained, such as the number of results found being large or small, as a result of the search performed through the process in FIG. 8 or 14, the image capture recipe list screen 1600 with the search function may be used instead of the image capture recipe list screen 900.

According to the above-described configuration, image capture recipes for images captured by different image capturing device from the image capturing device used by the user can also be output as search results. Thus, compared with searching by image capturing device name, a wider range of image capture recipe options can be provided to the user.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-176785, filed Oct. 8, 2024, which is hereby incorporated by reference herein in its entirety.

What is claimed is:

1. An apparatus comprising:
a first acquisition unit configured to acquire a range of setting values settable for a capturing device;
a search unit configured to search sample content stored in a storage unit for sample content corresponding to an image captured using a setting value within the range of setting values acquired by the first acquisition unit; and
an output unit configured to output a search result from the search unit.

2. The apparatus according to claim 1, further comprising:
an acceptance unit configured to accept identification information of a user, wherein
the first acquisition unit acquires, based on the accepted identification information of the user,
a range of setting values settable for the capturing device associated with the identification information of the user.

3. The apparatus according to claim 1, further comprising:
an acceptance unit configured to accept identification information of a user; and
a second acquisition unit configured to acquire a range of setting values settable for a lens, wherein
the first acquisition unit acquires, based on the accepted identification information of the user,
a range of setting values settable for a capturing device associated with the identification information of the user,
the second acquisition unit acquires, based on the accepted identification information of the user,
a range of setting values settable for a lens associated with the identification information of the user, and
the search unit searches the sample content, based on the range of setting values acquired by the first acquisition unit and the range of setting values acquired by the second acquisition unit.

4. The apparatus according to claim 3, wherein the search unit searches, using a first search condition for searching for sample content corresponding to an image captured using a setting value within the range of setting values acquired by the first acquisition unit and a setting value within the range of setting values acquired by the second acquisition unit, the sample content stored in the storage unit for the sample content.

5. The apparatus according to claim 4, wherein in a case where a number of pieces of sample content found using the first search condition is greater than or equal to a first threshold, the search unit uses a second search condition for searching for sample content corresponding to an image captured using a combination of the capturing device and a lens associated with the identification information of the user to search for the sample content.

6. The apparatus according to claim 5, wherein the output unit outputs, in a case where a number of pieces of sample content found using the second search condition is greater than or equal to a second threshold, the sample content found using the second search condition as the search result, and outputs, in a case where the number of pieces of sample content found using the second search condition is less than the second threshold, the sample content found using the first search condition as the search result.

7. The apparatus according to claim 4, wherein in a case where sample content is not found as a result of a search performed by the search unit using the first condition, the output unit outputs entire sample content stored in the storage unit.

8. The apparatus according to claim 1, wherein the range of setting values acquired by the first acquisition unit is at least one range of setting values among ISO sensitivity, shutter speed, white balance, exposure compensation, sharpness, contrast, color saturation, and color tone.

9. The apparatus according to claim 3, wherein the range of setting values acquired by the second acquisition unit is at least one range of setting values for lens aperture value or lens focal length.

10. The apparatus according to claim 2, further comprising:
a third acquisition unit configured to acquire information regarding a type of subject associated with the identification information of the user, wherein
the search unit further searches for sample content associated with the type of subject acquired by the third acquisition unit.

11. The apparatus according to claim 3, wherein the storage unit stores information for identifying a number of images captured using a first combination of the capturing device and a lens and information for identifying a number of images captured using a second combination of the capturing device and a lens, and
in a case where the number of images captured using the first combination is greater than the number of images captured using the second combination, the output unit outputs the search result such that sample content corresponding to images captured using the first combination is displayed on a display screen with priority over sample content corresponding to images captured using the second combination.

12. A system comprising:
a first acquisition unit configured to acquire a range of setting values settable for a capturing device;
a search unit configured to search sample content stored in a storage unit for sample content corresponding to an image captured using a setting value within the range of setting values acquired by the first acquisition unit; and
an output unit configured to output a search result from the search unit.

13. A non-transitory storage medium storing a program causing an apparatus to execute a method, the method comprising:
first acquiring a range of setting values settable for a capturing device;
searching sample content stored in a storage unit for sample content corresponding to an image captured using a setting value within the range of setting values acquired in the acquiring; and
outputting a search result from the searching.

14. The non-transitory storage medium according to claim 13, wherein the range of setting values acquired by the first acquiring is at least one range of setting values among ISO sensitivity, shutter speed, white balance, exposure compensation, sharpness, contrast, color saturation, and color tone.

15. The non-transitory storage medium according to claim 13, further comprising:
accepting identification information of a user,
wherein the first acquiring acquires, based on the accepted identification information of the user, a range of setting values settable for the capturing device associated with the identification information of the user.

16. The non-transitory storage medium according to claim 15, further comprising:
second acquiring information regarding a type of subject associated with the identification information of the user,
wherein the searching further searches for sample content associated with the type of subject acquired by the acquiring.

17. The non-transitory storage medium according to claim 13, further comprising:
accepting identification information of a user; and
second acquiring a range of setting values settable for a lens, wherein
the first acquiring acquires, based on the accepted identification information of the user, a range of setting values settable for a capturing device associated with the identification information of the user,
the second acquiring acquires, based on the accepted identification information of the user, a range of setting values settable for a lens associated with the identification information of the user, and
the searching searches the sample content, based on the range of setting values acquired by the first acquiring and the range of setting values acquired by the second acquiring.

18. The non-transitory storage medium according to claim 17, wherein the range of setting values acquired by the second acquiring is at least one range of setting values for lens aperture value or lens focal length.

19. The non-transitory storage medium according to claim 17, wherein the searching searches, using a first search condition for searching for sample content corresponding to an image captured using a setting value within the range of setting values acquired by the first acquiring and a setting value within the range of setting values acquired by the second acquiring, the sample content stored in the storage unit for the sample content.

20. The non-transitory storage medium according to claim 19, wherein in a case where a number of pieces of sample content found using the first search condition is greater than or equal to a first threshold, the searching uses a second search condition for searching for sample content corresponding to an image captured using a combination of an image the capturing device and a lens associated with the identification information of the user to search for the sample content.
